(19) United States
(12) Patent Application Publication
(10) Pub. No.: US 2007/0269271 A1
(43) Pub. Date: Nov. 22, 2007

(54) High Speed Line Carrier

(76) Inventors: William Kent Smith II, Lake Worth, FL (US); James G. Cunningham, West Palm Beach, FL (US)

Correspondence Address: Henry C. Gugel Jr., 3031 Casa Rio Court, Palm Beach Gardens, FL, 33418, US

(21) Appl. No.: 11/306,909

(22) Filed: May 14, 2007

(51) Int. Cl. F16L 7/00

(52) U.S. Cl. 405/183.5

(57) ABSTRACT

Whereas pull lines are utilized for installing electric wires in electrical conduit between junction boxes by attaching a pull line to the open end of a high-speed line carrier closed by an elastomer molded bulb of specific dimensions relative to the type and size of conduit and in which the hollow core device is slightly smaller in diameter than the conduit through which it travels, said combination of hollow core and molded bulb fashioned to complementary conduit creating physical characteristics, including a frictionless seal, allowing same to travel through conduit at high speeds, measurable in feet per second with little resistance, in response to a vacuum created at opposing end of conduit, or in response to a driving force of air applied at insertion point of same, or in response to a combination of these means. Additionally, usage on larger scale applies to waste disposal networks with same results.

### SUMMARY

This invention relates to apparatus and methods of installing utility and/or service lines such as telephone and/or electrical wiring and/or sanitary ancillary cables within and throughout conduit and/or pipeline and/or any other type of hollow cylindrical delivery device used for such purpose as herein described.

Conventionally, in the installation of junction boxes and public street/roadway lighting systems and the installation of septic/sanitary systems, conduits and pipelines are put in place to admit the insertion of wires and ancillary cables which interconnect the junction boxes and lighting systems and service or allow for the inspection of septic and/or sanitary systems, such lines and conduits varying in length and diameter and usually having one or more bends in them and installed within the walls of a completed/newly constructed building within the ceiling and/or floorboards and also underground, after which, the appropriate electrical wiring or ancillary cable is placed through these lines/conduits in order to allow for the completion of the system for which they are provided.

### BACKGROUND

Historically, these wires and cables have had to be fed through the conduits and lines by means of a pull line or rope or other type of cord like material, which originally would be “fished” through the conduit. This process involves the use of “fish tape”, which is a thin, yet resilient and flexible metal, wire, or nylon material that can be inserted through one end of the conduit or pipeline and pushed through such conduit or pipeline, after which the wires and cables would be attached to the end of this “fish tape” and then pulled through the pipeline or conduit, thus completing the task. Typically, the average distance of these conduits varies from 30 to 200 feet, although some systems are known to be as much as 650 feet in length. (It might be concluded that the current length of such systems has been limited, due in part to the fact that the process of pulling line through such systems has also been limited, as a result of the current methods and devices employed to pull such line through these same systems). In addition to this there are typically bends in these systems, although in the case of electrical systems the number of bends is limited.

While these systems are typically clear, there is the possibility and likely probability that due to the time from installation of conduit/line systems to the actual installation of the wires and/or ancillary cables, certain materials and or objects could accumulate within these systems, such as dust and/or dirt and/or insects and/or small rodents and/or water or some other liquid. While the accumulation of such items would not be expected in any way to be of a large or significant amount or quantity to warrant any concern, they could be substantially significant to create difficulty or delay for the installation or feeding of pull line through such systems, not so much in the way of interfering with the application of “fish tape” or a feed wire, but definitely enough to prevent or significantly slow down the process of drawing or feeding line with the use of later forms of line carrying devices and guides which are about to be explained. Additionally, in certain construction methods, there is the added possibility of aggregate/concrete debris accumulation in the pipeline systems/conduit to the point where such accumulation would actually prevent a line carrying device from completing its'circuit.

In order to facilitate the process of drawing lines and cables through their respective conduits and pipelines and to simplify the process, the idea was introduced of attaching the line, cord or rope to a projectile or missile which is then inserted into the conduit and either driven through the pipeline or conduit by means of high pressure air or drawn through by means of a vacuum attached to the end opposite of the insertion point. This method was intended to allow one to feed line through a conduit or pipeline in such a manner as to save time. Since the fish tape and or feeding wire was typically limited in length, the application of a missile or projectile as a means for carrying line or wire was thought to be a good alternative to the former, since there was essentially no limit to the amount of line that could be drawn or driven through the conduit and in all but extreme cases of accumulation of debris or blockage within these line systems, the line carrying device could typically be utilized successfully. (At least, this was the idea in theory).

In our initial search for prior art pertaining to these types of missiles and projectiles, and in our checking and re-checking references and cross referencing the same, we came across several interesting examples of line carrying devices and all other types of devices pertaining to the running or threading of line through conduit and also pertaining to the cleaning and maintenance of pipeline and other related items. As some of these items were not related in their use or appearance to ours, we have removed them and have left those items that more closely come into association with our invention. We are fairly certain those currently listed herein should be sufficient and appropriate to form concrete conclusions as to the patentability of our invention. Of the list of cited references, two of them were interesting to us. Loane U.S. Pat. No. 252,956 appears to be the first historical example of a line carrying device for subterranean pipe and Steigleder U.S. Pat. No. 979,899 appears to be the first historical example of utilizing line carrying devices in the threading of electrical wire through conduit.

While such projectiles and missiles have taken several forms and shapes and while the initial concept of utilizing said missiles or projectiles has been as a vehicle for the introduction of pull lines or cables through their respective conduits, these items proved to be ineffectual, as their physical qualities and dimensions were such as to ultimately prevent their use in the application of line over long distance, as they were not designed in such a manner to be lightweight and conforming to the inside dimensions of the conduit in order for them to travel throughout the entire length without stopping or slowing down. Along these lines, however, there has been some development in the way of design and implementation of line carrying devices, of which there are two items that have been discovered as being designed to be better than the previous items in use. While these items were intended to solve the problem of their predecessors, they have still not proven to be effective in the field, as they are not consistent in their operation and while the latter of the two items has been claimed to work more effectively, this item does not appear to be in use in the field at this time, while its' former counterpart is still used, albeit in a limited capacity.

The two items referred to would be the “mouse”, which appears to be described in U.S. Pat. Nos. 3,244,402 and 3,244,403 by Glover Ensley as an “Apparatus for installing lines through conduits” (and actually is referenced in several other patents and referred to as a “conduit piston” of which we have listed herein, but have chosen Ensley as our primary reference.) and U.S. Pat. No. 4,596,381 by James Hamrick which is described similarly as an “Apparatus and method for installing line in conduit.” (We have listed several other patent references of Hamrick, which appear to be predecessors of the U.S. Pat. No. 4,596,381 but were not referenced in this later patent. The U.S. Pat. No. 4,596,381 was chosen for reference herein as it is the only item that bears some resemblance to our invention, but lacks in performance, as its' physical characteristics again do not allow it to function on a level equal to our invention, when the physical laws of nature are applied).

Additionally, it should be added that while we have listed the two inventions of Ensley and Hamrick as being primary examples of current field use line carrier devices, our discovery of Brockelsby III patent was quite interesting, as the idea for the line carrier being streamlined so as to allow for its' susceptibility to small changes in effecting force of air gives it a quality relative to our own invention, as this feature is necessary and pre-requisite to an objects' obtaining a low relative mass, which combined with little or no friction, contributes to the equation of Newton's 2^{nd} law of motion (F=ma), pertaining to an objects acceleration. We believe, however, that the concept of the design of this invention as claimed would not be ideally congruous to its relative surroundings under conditions involving the possibility of unknown variables.

This particular invention had a detailed history of prior art, most of which we had claimed, but without the detailed examples, which we found quite informative and relevant. These items described are also relative to our invention, and again as they were not as similar to our own invention, we felt they did not bear further elaboration, with the exception of Ensley U.S. Pat. No. 3,403,838 and Hamrick U.S. Pat. No. 3,840,303. Apart from these similarities (The light weight and the fact that it is dissimilar to all other items currently in the field at that time) however, we would say that there are extreme differences afterwards in performance, again simply due to the physical specifications of each object as they relate to their dynamic relationships with the environment of a moving cylindrical field along a horizontal line of force. Since this object is not symmetrically aerodynamic under these circumstances, its output is necessarily unpredictable, which leads us back to the other two inventions.

While the invention of Ensley is more involved with claiming the method and device used for dispensing line through conduit, the line carrier which is made a part of the line dispensing mechanism is descriptive of that commonly referred to in the field as a “mouse”, consisting of two plastic discs of a circular shape containing a cylindrical section of foam, the discs being held in place by a metal pin of considerable thickness, with an eyelet on each end, being outside of such discs, through which can be attached a pull line, which in this case is part of a line dispensing mechanism, located within a tube extending from one end of the mechanism to the opening of the conduit to which the line carrier will be admitted, the opposite end of the line dispensing mechanism connected to a tube which extends from there to an actual blower unit. When the blower unit is engaged, the subsequent pressure of the air is such as to drive the line carrier through the conduit to the other side. (For complete details of the actual construction and method of application for this and the subsequent invention, please refer to the patents as herein referenced).

While the method as described and the utilization of the type of line-carrier device again appear to be sound, unfortunately, trial use of this device in the field has not yielded the expected results as claimed. While the sponge device or “mouse”, appears to be of a better design than its predecessors, and while the idea of the line dispensation system is a good one, the use of the “mouse” in the field has been limited, as it tends to get caught up in most line or conduit systems, as the cylindrical shape of the object, combined with the fact that it is supported on its' outside edges by solid plastic circular discs and further, that these disks are held in place by a solid metal pin of relatively thick gauge, ending in the formation of an eyelet at either end, causes the object to be rather inflexible, even though the sponge allows for the two discs to be compressed against each other, as this does not alter the fact that the combination of the discs with the solid metal pin, with or without a sponge added thereto, while forming what appears to be a rather airtight seal which should allow for the movement of this object through a pipe or conduit, the solid nature of the item is such that it is prevented from moving easily around or through 90 degree turns or even turns of a lesser degree, especially if there is no slow gradation in transition to the angle, which in most cases is true to the nature of such system.

Furthermore, the addition of any dirt or material within the pipeline or conduit will further prevent the movement of this type of line carrier through the system as the force of the air working in connection with the movement of the line carrier is not of a nature in which it increases or provides for a fluid movement throughout the conduit. In fact, the introduction of any detritus or unwanted material within the conduit is sufficient to slow down and possibly block the movement of this type of line carrier through the conduit entirely. (Especially in the case of aggregate accumulation, in which case there would be no further movement of the unit through the system to which it is introduced).

Additionally, the collection of any moisture within the conduit, which is typically more common than dirt or other debris, especially if there is a short interval of time from the actual installation of the pipe to the installation of wire and/or cable is such as to cause the foam material absorb moisture/water and to expand, thereby increasing in density and in most cases, stopping the progress of this device through such conduit. When this does happen, the device has to be removed from the conduit, wrung out, and fed back through the conduit. This process usually lasts some time. Added to this, the typical cost of this item is not in proportion to its size and construction (i.e. being priced more than should be expected) and it is not found to be commonly used in the field to this day and if it is used, it would have to be under ideal conditions. Most Electricians in the field are using alternative means to thread wire through conduit, as this process does not expedite operations when compared to the usage of the old-fashioned method of “fishing wire” through a system, which, though time consuming and labor intensive, yields more consistent results.

The last item of interest, (Hamrick U.S. Pat. No. 4,596,381), which appears to be the latest edition in devices designed for pulling line through conduit in order to subsequently run wires, while presented as a means for improving upon the method previously described above, appears to be even less effective than its predecessor, although it is claimed to be a substantial improvement. This device, while it could easily be confused so as to be similar to our device from an initial observation of the drawings and/or figures of such device, is in no way identical, apart from the fact that it is meant to be a line carrying device utilizing air or fluid to help transport it through conduit or pipeline. Indicative of its functionality in the field, (or counter-indicative, as the case may be), this item has not been used in the field to our knowledge and is not seen to be in common use. This is apparent for the reasons subsequently enumerated upon. While the idea appears to be sound and is based upon the same principal of using a missile or some similar vehicle, in this case a “bag-like” device for the purpose of pulling line through cable and/or conduit, or again specifically in this case, electrical conduit, the dimensions and construction of the object are such that, when pressure is applied to the object in order to blow it or drive it through a conduit or similar delivery device, the device itself presents several different obstacles in the way of drag and/or limitations to movement, that it easily becomes obstructed or creates an obstruction within any conduit of which it is specifically designed to service, principally in part to its construction and the physical laws of nature.

The device, while “bag-like” thereby allowing it to retain air, is constructed to be similar in construction to a bladder or water pouch and as this shape is typically not congruous to that of its' receiver, also due to the fact that the outer diameter of the pouch is greater than that of the inside diameter, as claimed, of the conduit through which it is introduced, even when inflated, there is created enough friction and limiting stimulus in order to effectively slow down and/or stop the device from movement shortly after it has been effected. Additionally, the object is not proven to be effective in moving through a conduit utilizing pressure from either side of the device, simply by applying laws of physics and movement/velocity, as well as those pertaining to fluid dynamics, as the overall dimensions and construction of the device are such as to prevent the unit/device from attaining any force to counter/exceed its' drag potential. (It has, however, been noted that the device can and has been employed to move with an extreme amount of pressurized air applied to the point of insertion, however, there is encountered with this method a consistent problem of the actual “bag-like” or bladder portion of the unit being blown off the through bore portion of the unit due to the fact again that the design of the unit runs counter to its' efficiency in application.)

Add to this the fact that the majority of these devices are designed to be blown or driven through a conduit by fluid pressure from behind the device, as it has been inserted into the conduit and that the device itself has line inside of it or behind it which is constantly being unraveled while it continues its' forward movement through the conduit, the addition of wire creating a continually growing barrier to the pressure responsible for providing its' forward momentum, (which, in the case of an entirely aerodynamic line carrying unit, as later herein described, would typically be of minimal concern), the expectations of this device are not brought to fruition.

While the operation of this device appears to be principally involving a means of pressure/fluid application in such a way as to push the unit through the conduit to which it is introduced, there is also the possibility (at least as claimed in the body of the patent-as there appears to be no working example of this method of operation in the field) of it being used to pull wire through a conduit by means of applying a vacuum to the opposite end of the conduit to which it is being introduced, in such instance, the “bag-like” member, which is typically in a collapsed or uninflated state is thereby inflated and a plug is inserted therein in order to keep the “bag-like” member inflated in order that it may connect with the inside of the conduit and maintain continuous contact with the surface in order that it forms a seal and is drawn through the conduit. This type of device is to be inserted within the conduit and then inflated, although the method for doing this and thereafter applying the plug therein to seal it, while inside the conduit, does not appear to be explained in a clear manner.

In any event, while the description of the operation or expected operation of this apparatus when working in conjunction with its' surrounding environment, appears to be of such a nature that it would be complimentary to the operation and implementation of such device, its' apparent usage in the field does not appear to produce the same harmonious results. Again, it would appear that the dimensions of the “bag-like” member, as they are larger than the inside diameter of the conduit to which they are introduced and again, as they are not congruous to the receiving material, these factors present obstacles to the effective movement of this same object through the conduit, stopping it short from producing any desired or expected results, again taking the electrician back to the tried and true method of the “fish-tape” or some other alternative method for which there is yet no better remedy.

### DESCRIPTION

Until now, of course, as our device incorporates the idea of utilizing a transport vehicle to which pull-line, or cord, or rope is attached and which being moved by pressure, either in the means of air driving it through the conduit, or in the means of a vacuum drawing it through the pipeline, either method being possible with very little difference, although the vacuum means appears to be preferred as no drag or obstacle is created between the object and its source of movement, whereas in the case of pressurized air driving the object, there is the factor of the cord/rope/pull line creating an increasing barrier to the pressure applied. While this is mentioned as a means of reduction or drag, the resultant drag is very slight, in comparison to the overall results of the device and its effectiveness. ( In fact, the principal reason for the method of vacuum as being preferred over compressed air is due more in part to the advantages in safety and practical application/cost effectiveness, as the use of smaller compressed air systems involves air canisters, which are easily and quickly expended, creating a time delay and cost obstacle in the fact that they have to be replenished often and also the fact that compressed air canisters and electricity and/or heat sources are not exactly a safe combination, especially among the inexperienced. The larger compressed air units are also extremely bulky/cumbersome and in the field proven to be counter-productive, whereas the commercial vacuum is much easier to handle due to its' smaller size and light weight and the fact that there is no danger of combustion or explosion from it's' use in the field. Also with the large compressed air units, the cost range is over $1,000.00 and up, whereas a shop-vac runs $200.00 on the average and up to $1,000.00 maximum).

The device itself consists of a molded elastomer latex or semi-permeable slightly elastic membranous bulb, of such dimensions as to create an immediate frictionless seal when introduced into the pipeline and/or conduit presenting little or no drag on the device, the same being connected to an open-ended through bore extending lengthwise thereof, to which is attached at its' trailing edge, a cross-wire for the connection of a pull-line or cord, or rope. The dimensions of the bulb are such as to compliment the conduit to which it is designed to service and when working in combination with its' other parts is of such a nature that it is immediately drawn into a receiving conduit when a vacuum pressure is applied to the end opposite of the receiving end, so long as it is directed towards the receiving hole and within a reasonable distance from same, after which, the subsequent force of its' being drawn into the conduit, even though the vacuum pressure applied on the opposite end is a standard pressure as exerted from any standard commercial shop-vac, is such that the unit is drawn through the conduit in an incredibly short period of time. So far, in every test application of our device, which has involved varying lengths of pipeline and conduit, as well as sizes varying from ½″ in diameter to 10″ in diameter, the speed of our line carrier can only be measured in feet per second and typically, when used in the manner of applying a vacuum to the receiving line, a 100 foot line is run with guide line in about three seconds. This behavior of movement is consistent, regardless of the size and/or length of pipeline and/or conduit, as long as the proper size device is being used to service same and so far, over a three month time period, we have run well over 150,000 feet of line and this was done during this time period during regularly scheduled work days, in which case the time allotted for the electrical cord dispensed comes to roughly 10 hours, which equates about 15,000 feet of line run per hour. Prior to the use of our invention, this was unheard of with the use of line feeding devices.

This ability of our invention to travel in feet/second is due simply to its designed construction, as it is elliptical in shape, such being that when introduced into a cylinder matching its' midpoint diameter, when a motivating force is present, it is immediately drawn into such cylinder, as its' symmetry allows for the air to flow around it, creating an air bearing, or frictionless seal, after which, all objects of negligible size/mass are removed from such cylinder, either by being pushed out by the line carrying device, or by being sucked through. (Some objects are actually passed over by the device, as illustrated FIG. 5a, after which, due to the filling principle of air from the increasing pressure differential, are then being pushed behind the device and in some cases, inside of the device). Such action also is consistent in causing the object to rotate around its' central (radial) axis, which phenomenon, we believe, further contributes to its' speed and ease of movement through such system.

This frictionless seal is a quality inherent in our device and unique to our invention and is also the cause of the units' ability to travel at such speeds. No other type of device currently on the market today can claim this as a quality. We are absolutely certain that the introduction of this device will revolutionize the field of preparation in such a manner, that considerable time, money and effort will be saved, as this device will effectively eliminate the use of any other device for installing line in conduit, since it effectively renders most other items obsolete. Also as mentioned previously, in the case of debris such as aggregate accumulations, our unit, while prevented in its' movement through its' respective system, is still able to be employed with a 99% certainty of success, in the removal of such aggregation from said system, while still within same, after being so prevented, as will be described in the subsequent paragraph.

Additionally, this item can be used for the installation of other utility lines in pipelines and/or conduit, as well as for the addition of ancillary cables into septic/sanitation systems and we have working prototypes varying in size from ½″ to 10″ in diameter, in relation to their complimentary conduits and/or pipelines for which they are designed, again, all being able to travel through such systems in feet per second, due to the fact that they are all designed to create a frictionless seal, simply by their shape being aerodynamic, thereby earning the designation of being classified as “high-speed” line carriers. According to the laws of motion, (specifically, Newton's second law), due to the objects' small overall weight and mass and its' fluid design, thereby allowing no friction within a cylinder, while moving, when a resultant force is applied to this object, the result yields consistently in an average speed of travel at 32 feet per second. (This does not mean, however, that the object is limited to this speed alone as in several cases of field application, it has already proven to travel at speeds above this number).

The only instance in which flow of the high-speed line carrier through the conduit or pipeline is prevented is in the way of broken conduit and or pipeline of such a nature that it actually creates a physical barrier to the continuity of the operation, or in the accumulation of aggregate/concrete within such systems, usually as the result of the after-effects of certain methods of construction (i.e. tilt-wall construction) in which the conduit/pipeline systems are typically encased in concrete, in which case, we have designed the unit so that it can be pulled out from the exit point by means of “fish-tape”, (the through bore of each unit being designed to be slightly smaller than the actual diameter of its' respective pipeline/conduit for this very reason), simply by inserting the “fish-tape” past the membranous/elastomer bulb and coming into contact with either the through-bore itself and/or the guide-line connecting wire after which such “fish-tape” is pulled back from whence it came and thereby continuing to pull the entire unit, along with the aggregate accumulation/blockage through its' respective system, thus completing the process of drawing the feed line and also removing the blockage without the extra cost and time of having to cut through the concrete and remove the matter in the previous and only manner it could be removed until the introduction of our invention.

In the case of an actual breakage of pipeline/conduit, the unit would typically be pulled back from its' insertion point and the amount of line used up until the point of blockage measured to determine the location of the actual break, after which the system would be repaired and the operation continued, with typical success, unless there would be further blockage and/or breakage, which is typically not common. (It can be commented, however, that if such is the case, the introduction of our invention into the equation, subsequently will alleviate a good portion of the time, effort and aggravation associated with such calamities). The problem associated with the units' blockage can typically be determined by the surrounding environmental evidence, observed by the operator in the field. (i.e. the material being drawn up to the point of blockage by the vacuum unit or being blown out by the compressor unit and also the attendant sounds and effects of the air itself as it is being utilized within the actual pipeline system/conduit, in addition to the type of construction methods being employed in the actual placement of such conduit/system notwithstanding the actual experience of the individual in the field themselves).

Once again, it cannot be over-emphasized that the introduction of this new method of line transmission will greatly improve work in the field for the professional, allowing them to focus on other matters by freeing up a good portion of their time, which would have been previously spent in the way of installing pull lines through conduit.

### DESCRIPTION OF DRAWINGS

FIG. 1 is an illustration of a sectional view of the high-speed carrier A., showing its' relationship to the cylinder B. in which it is to be inserted. (In this drawing, the line carrier/high-speed carrier A. is actually inside the cylinder B., to better illustrate the relationship of the two). The figure illustrates the open-ended through-bore, A-1., attached to the hollow elastomer bulb, A-2., and additionally, the relationship of the bulb A-2., to its' overall shape including the through-bore A-1., and the dimensions of the cylinder B., itself. The wire, or guide-line connecting wire, A-3., to which is attached the guide-line C., is at the open end of the through-bore, A-1., as illustrated. Note that the through-bore A-1., is smaller than the inside diameter of the cylinder B., and the outside diameter of the largest part of the bulb A-2., diametrically is identical to the inside diameter of the cylinder B. Additionally, the illustration allows the viewer to observe the fact that the bulb A-2., itself is hollow, which as explained previously herein, contributes to the units' coefficient of friction, allowing for a relatively small mass in relation to the overall size of the object and a low center of mass, allowing the unit to achieve a relatively fast rate of acceleration in a very small period of time, with a nominal application of external force, while still creating a seal with the delivery device through which it travels. (Such seal, incidentally, being frictionless, due to the nature and physical attributes of the object in question).

FIG. 2 is an illustration of the line carrier A., traveling through the cylinder B., showing the phenomenon of central axial motion or rotation of the line carrier A., around its axis through the cylinder B., while traveling within same, and the rate of rotations per second/distance traveled. (One rotation for every second/32 feet).

FIGS. 3A-3B illustrate the principle of fluid displacement. In the case of FIG. 3A, the figure shows how fluid within the cylinder B., reacts when the relative mass of the fluid displaced is such that combined with the rate of equal & opposite acceleration, the fluid is exerting a force less than that created by the line carrier A. itself while traveling through the cylinder B. In the case of FIG. 3B, this figure illustrates what would happen if the total force exerted by the fluid through which the line carrier A., is traveling is greater than the force of the line carrier A., itself, in which case the fluid would be displaced around or past the line carrier A., and still not affect the line carrier A's total drag, due to the fact the line carrier A. would still not be in contact with the cylinder B., and yet still creating a seal, with the air/fluid forming an air/fluid bearing between the cylinder B. and the line carrier A., again with effectively no friction. Additionally the axial rotation of the line carrier A., while contributing to the acceleration of same, also helps functionality and motion while the line carrier A., is within the line system. The process of air/fluid filling behind the unit, due to the pressure differential caused by the units' movement through the cylinder B., also causes some of the debris passing by same to be sucked inside the membranous bulb A-2, in the process. This phenomenon in no way deters from the speed or overall performance of the unit.

FIGS. 4A-4E illustrate the method of pulling the line carrier A. through the cylinder B. from the opposite side of the entry point of line carrier A. by means of a fish tape D., in rare instances in which the unit is prevented from traveling through the cylinder B. by circumstances as previously described herein, excepting the situation of accumulation of aggregate, which will be separately illustrated in the next set of figures. (In this illustration, for simplicities sake, the problem/circumstances are exemplified by the dotted letter X). In such cases, as illustrated, the fish tape D. is run through the cylinder B. from the opposite end of same (the egress point) to the point were it meets with the line carrier A. (FIG. 4A). At this point the fish tape D. is pushed past line carrier A. (FIG. 4B), and then pulled back until it actually catches hold of the guide-line connecting wire A-3., attached to the open ended through-bore A-1., (FIG. 4C) or to the actual through-bore A-1., itself (FIG. 5: explained separately), at which time the fish tape D. is pulled back further, such action causing the line carrier A. to flip around inside the cylinder B. (FIG. 4D), thus causing line carrier A. to have completely reversed within the cylinder B. and allowing for easy retrieval from within same, simply by pulling the fish tape D. back towards the point of insertion of same (“same” describing of course the fish tape D., which subsequently is pulling line carrier A. out through its' original designated path of egress), and also drawing guide line C. behind line carrier A., still completing the circuit/line system as originally planned. (FIG. 4E).

FIGS. 5A-5B illustrate the example of actual aggregate accumulation and also the alternative method of capture by the fish-tape D., in which the fish-tape D., actually comes in contact with the through-bore A-1. of the line carrier A. ( It is made mention herein that either method of capture—i.e. the through-bore or the guide-line connecting wire A-3, will yield the same results in removing accumulation of aggregate from the cylinder B.) which method of capture is first illustrated by FIG. 5A., which also shows a rather large amount of accumulated aggregate E. In FIG. 5B, the line carrier A. has been pulled through the cylinder B., by the fish-tape D., to the point where the through bore A-1., has come into contact with the accumulated aggregate E., after which the further pulling of the fish-tape D., will pull the aggregate E., through the cylinder B., and also still drawing the guideline C. through same, thereby completing the circuit and also successfully removing the aggregate E. from the cylinder B. without actually having to drill through concrete in order to remove same.

FIG. 6 shows the favored method of application wherein a commercial vacuum unit 2H, after being plugged into an electrical circuit by means of its respective electrical cord 1 H is applied to the opposite end of insertion at the conduit/cylinder B of the high speed line carrier A through the electrical panel I by means of the vacuum hose 3H, while the line carrier A itself has been placed at the insertion point through the junction box G and as shown in the illustration, is being sucked through the pipeline/cylinder C, while drawing line C through the cylinder C, such line having been attached to the line carrier A's guide-line connecting wire (A-3, as previously illustrated, but not shown in this description) and the line C itself being drawn from a spool F, or other similar such device, allowing the line C to be drawn without tangling. When this method is utilized by itself, using a standard commercial type vacuum, the speed of the unit through the pipeline, regardless of the size of the unit and its' related pipeline network, ranges from 32 to 37 feet per second.

FIG. 7 shows the alternative method of application wherein a compressed air unit 1J is applied to the point of insertion through the junction box G by means of a pressurized air hose 3J and regulated by means of the regulation valve 2J, after the high speed line carrier A has been inserted within the pipeline/cylinder B, allowing for insertion through the pressurized hose 3J for the guide line C to be fed through the conduit/cylinder B from the spool F, while the compressor unit 1J is applying pressure to the carrier unit A which will be received through the electrical panel I. In this application, the speed of the unit is still relatively the same (32 to 37 ft./sec.), although this method is typically not favored over the vacuum method, again typically for safety and the other reasons as herein enumerated.

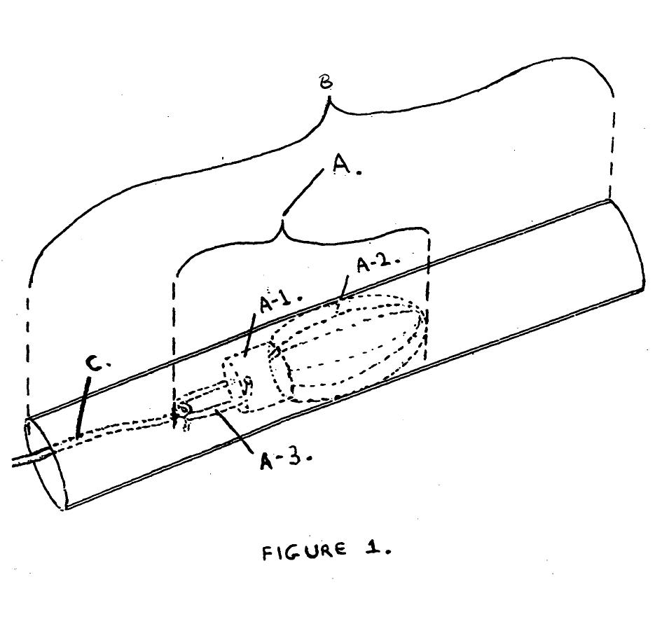

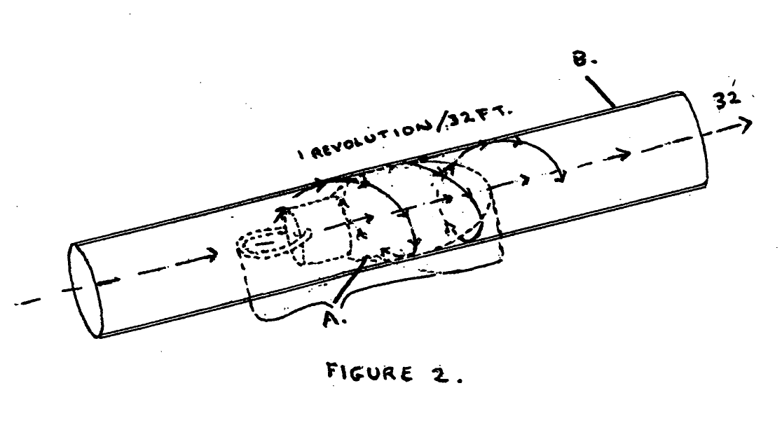

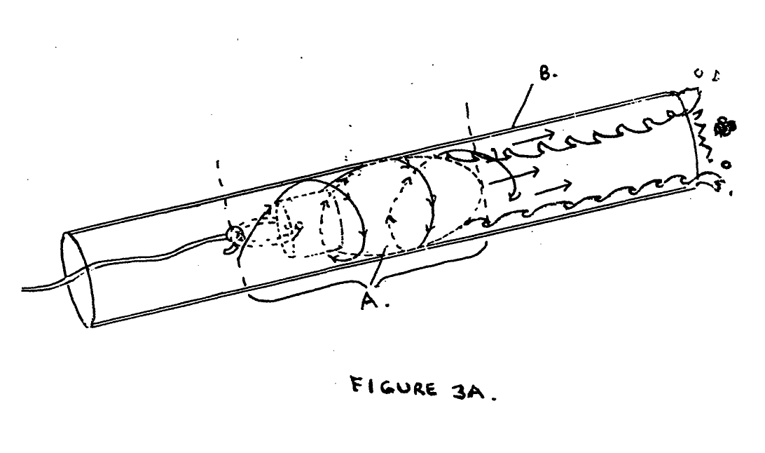

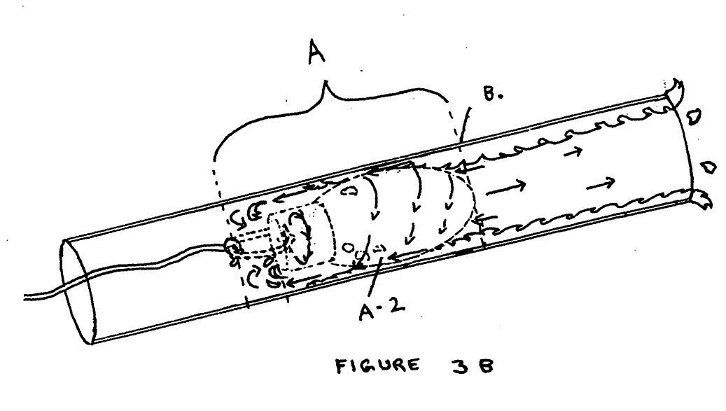

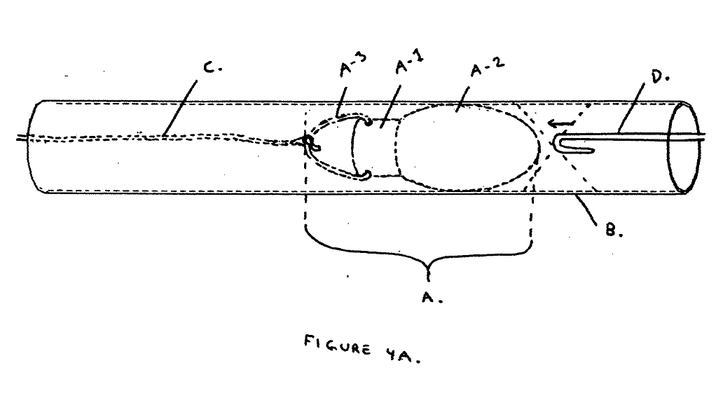

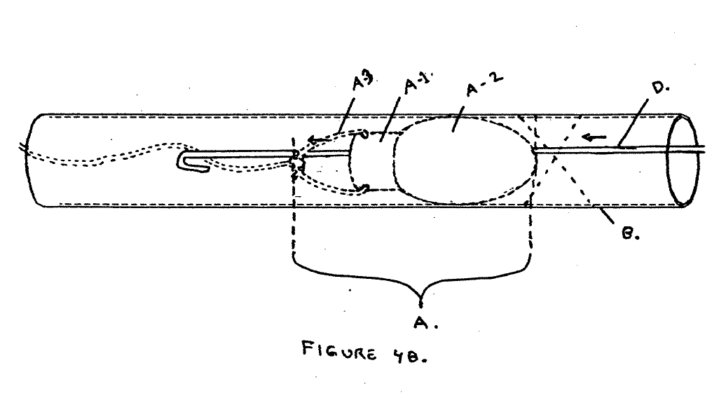

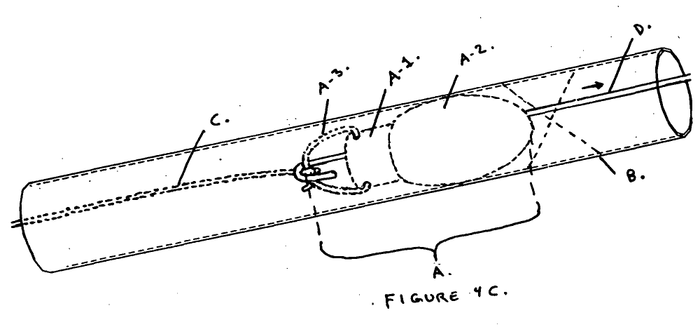

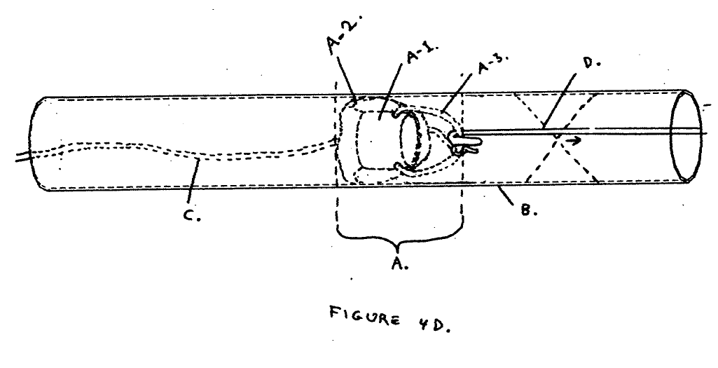

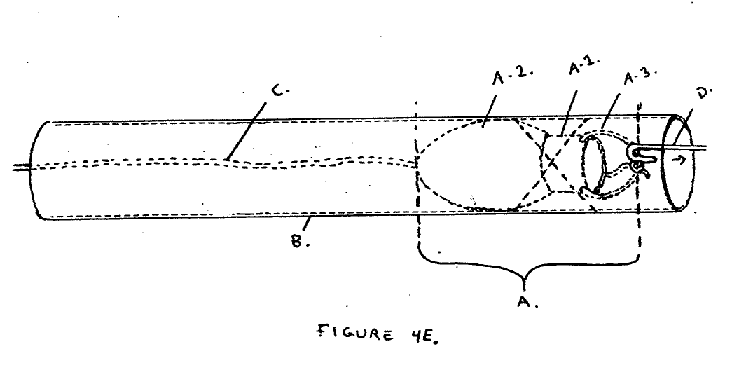

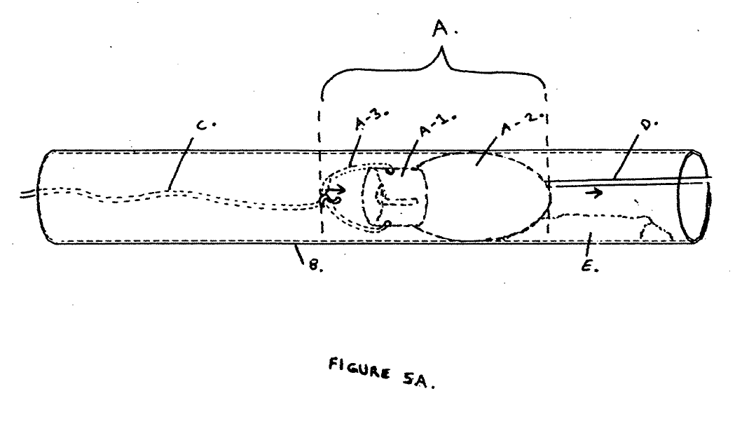

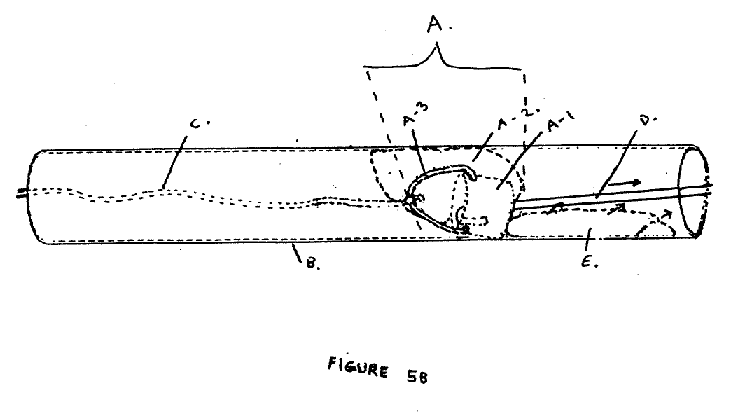

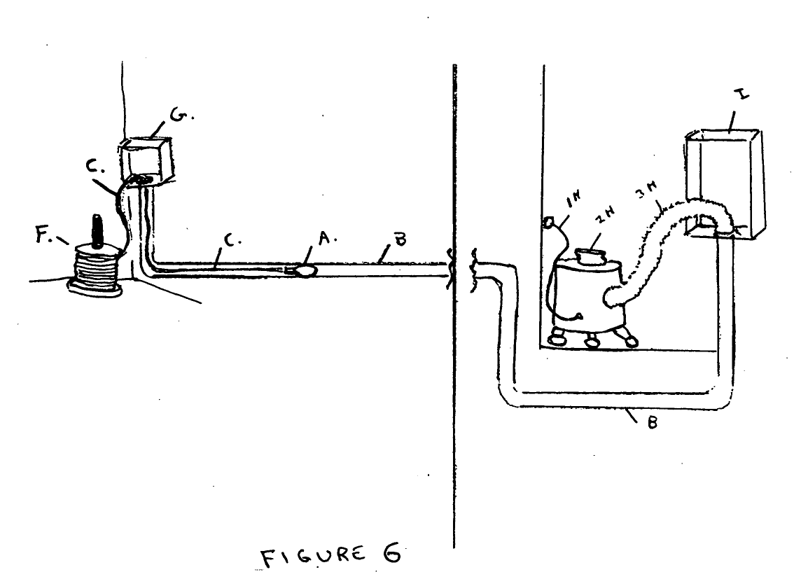

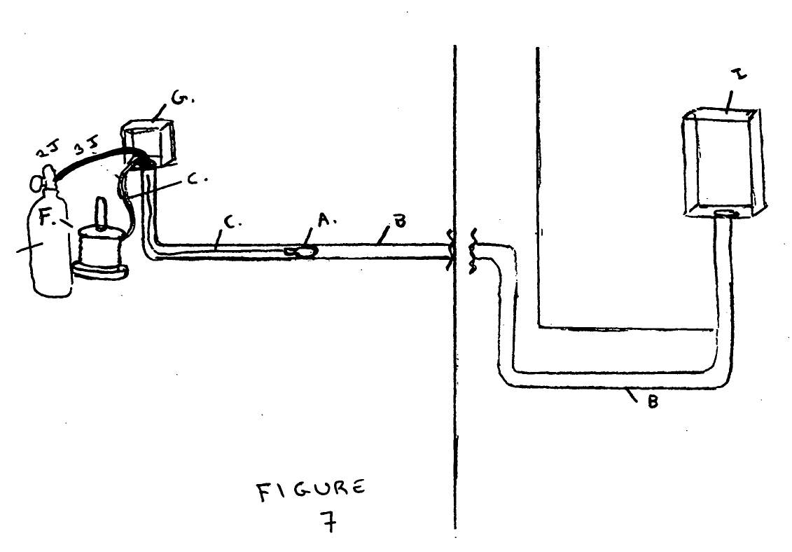

What is claimed is:

1. Apparatus for moving line through a conduit and/or pipeline and/or hollow cylindrical delivery device in response to a pressure differential created at one end of same, said apparatus comprising, in combination:
A cylindrical line carrier having an open-ended through-bore extending lengthwise thereof, said through-bore having an outside diameter less than the inner diameter of the conduit; and
a hollow molded elastomer bulb, having an outside diameter at its' midsection/midpoint equal to the inside diameter of the conduit;
said bulb being symmetrical and elliptical in its dimensions, as well as being hollow in its construction, such dimensions causing said bulb to have a larger diameter at its midsection/midpoint and equally smaller diameters at either end from such midsection/midpoint, such ends hereinafter referred to as the forward or leading closed end and the rearward or trailing open-end.

2. said bulb having a rearward or trailing open-ended portion fixed to the forward open end of the through-bore, the inside rearward diameter of said bulb being equal to the outside diameter of said forward open end of through-bore.

3. the line carrier comprising a cross-wire (hereinafter referred to as a guideline connecting wire) passing through the circumference of the through-bore at its' rearward open end for the purpose of attaching a pull line thereto.

4. Apparatus according to claim 1 wherein the outside dimensions of the through-bore and the elastomer bulb of every line carrier are consistently specific in relation to each conduit and/or pipeline and/or hollow cylindrical delivery device for which they are designed to service, such relationships being critical to their ability to function as high-speed line carriers as herein described.

5. Apparatus according to claim 1 wherein the said cylindrical line carrier has an overall cylinder length slightly longer than the length of the adjoining end of the said elastomer bulb.

6. Apparatus according to claim 1 wherein said hollow molded elastomer bulb is elliptical and hollow in nature, such dimensions allowing for it to function with consistent dynamic action, attributable to its' relationship with the pipeline/conduit/cylindrical hollow delivery device to which it is designed for use in same, such relationship occurring at such time as a motivating force is introduced therein, either in the method of applying air pressure to drive the unit, or in creating a vacuum within such pipeline/conduit/cylindrical hollow delivery device to draw unit through same.

7. A hollow molded elastomer bulb according to claim 1, in which such construction as herein described, where bulb is symmetrical in its design, being elliptical and connected to the through bore, such construction not impeding bulb from its' intended purpose.

8. A hollow molded elastomer bulb according to claim 1, in which such construction as herein described, where bulb is symmetrical in its design, being elliptical and connected to the through bore, such construction aiding in connection and removal from line to carrier.

9. Apparatus according to claim 1 wherein construction of unit /physical characteristics of same allow it to travel consistently at speeds in feet /second, such resultant action caused simply by the units adherence to the physical laws governing motion and acceleration.

10. Apparatus according to claim 1 wherein dimensions of said bulb allow it to be lightweight, such as to allow fluid (air) to flow throughout said bulb.

11. Apparatus according to claim 1, in which dimensions of said bulb are such as to allow it to essentially move through any pipeline and/or conduit and/or hollow cylindrical delivery device to which it is designed for admission through same, in such a way that it effectively removes unwanted material from within same, with minimal deviation from its standard velocity, attributable to such dimensions again allowing for its aerodynamic functionality/relationship.

12. Apparatus according to claim 1, in which dimensions and construction of said bulb, in combination with said through-bore and said guideline connecting wire are such when employed in its' intended purpose as to create central axial rotation while moving, such axial rotation attributing to the speed and functionality of said apparatus.

13. Apparatus according to claim 1, in which dimensions and construction of said bulb, in combination with said through-bore and said guideline connecting wire are such when employed in its' intended purpose as to create a frictionless seal while moving, such frictionless seal attributing to its' ability to move in feet/second and also its functionality.

14. Apparatus according to claim 1 wherein the rearward open-end portion of said bulb is secured to and about the forward open end of said through bore and also wherein the inner diameter of the rearward open-end portion of said bulb is equal to the outer diameter of forward open end of said through bore.

15. Apparatus according to claim 1 in which the working dimensions of such apparatus, in relation to the conduit to which it is applied, are such that allow it to be completely turned (180 degrees) while inside such conduit, by means of a fish tape or other similar such device applied opposite to the point of insertion.

16. A method of installing pull line through an open-ended conduit/pipeline/hollow cylindrical delivery device wherein:
the pull line/cord/rope is attached to the guide-line connecting wire of the open end of a high-speed line carrier as described in claim 1;
the bulb end of aforementioned carrier device is placed near the open end of the conduit/pipeline/hollow cylindrical delivery device through which the pull line/cord/rope is to be drawn, the pull line/cord/rope laying in a coil or wrapped around a spool and in such a way as to avoid tangling or resistance when drawn through at a very high speed and wherein:
a pressure differential is created within the conduit/pipeline/hollow cylindrical delivery device by means of a vacuum attached to the opposite end of same in such a way as to form a reasonably air tight seal, such pressure differential being sufficient to attract said carrier device into and through conduit/pipeline/hollow cylindrical delivery device thereby drawing pull line/cord/rope through same.

17. The method of installing pull line through an open-ended conduit/pipeline/hollow cylindrical delivery device as indicated in claim 13., wherein:
the method of connection as illustrated and claimed therein is not construed to restrict the claim so as not to allow any other developed method of connection thereto to be added or claimed by the inventor at such future as time may warrant.

18. The method of installing pull line through an open ended conduit/pipeline/hollow cylindrical delivery device as indicated in claim 13., wherein:
In certain problematical cases in which the movement of the line carrier is stopped due to a break in the conduit/pipeline/hollow cylindrical delivery device or any internal obstruction, including aggregate accumulation, a fish tape or other similar such retrieval device may be inserted into the conduit/pipeline/hollow cylindrical delivery device from the intended point of egress of the line carrier to a point past same, and then pulled back, such action culminating in the attachment of the fish tape or similar device to the line carrier which is then pulled out by such method as herein claimed, thereby successfully completing the circuit.

19. The method of installing pull line through an open ended conduit/pipeline/hollow cylindrical delivery device as indicated in claim 13, in which the line carrier in combination with the fish tape can be employed as a chisel or driving device to force the aggregate out of the conduit/pipeline/hollow cylindrical delivery device while still retrieving the line carrier and successfully completing the circuit.

20. A method of installing pull line through an open-ended conduit/pipeline/hollow cylindrical delivery device wherein:
the pull line/cord/rope is attached to the open end of a high-speed line carrier as described in claim 1;
the bulb end of aforementioned carrier device is placed just inside of the open end of the conduit/pipeline/hollow cylindrical delivery device through which the pull line/cord/rope is to be drawn, the pull line/cord/rope laying in a coil or wrapped around a spool and in such a way as to avoid tangling or resistance when drawn through at a very high speed, and wherein:
a pressure differential is created within the conduit/pipeline/hollow cylindrical delivery device by means of a high pressure device such as but not limited to: an air compressor, said device attached to end of conduit/pipeline/hollow cylindrical delivery device to which said carrier has been inserted, attachment of pressure device thereto such as to allow cord/rope/pull line to follow through and yet forming as air-tight a seal as is possible under such circumstances, such arrangement allowing line carrier to be driven through pipeline/conduit/hollow cylindrical delivery device.

21. The method of installing pull line through an open ended conduit/pipeline/hollow cylindrical delivery device as indicated in claim 1 7., wherein:
In certain problematical cases in which the movement of the line carrier is stopped due to a break in the conduit/pipeline/hollow cylindrical delivery device or any internal obstruction, including aggregate accumulation, a fish tape or other similar such retrieval device may be inserted into the conduit/pipeline/hollow cylindrical delivery device from the intended point of egress of the line carrier to a point past same, and then pulled back, such action culminating in the attachment of the fish tape or similar device to the line carrier which is then pulled out by such method as herein claimed, thereby successfully completing the circuit.

22. The method of installing pull line through an open ended conduit/pipeline/hollow cylindrical delivery device as indicated in claim 17, in which the line carrier in combination with the fish tape can be employed as a chisel or driving device to force the aggregate out of the conduit/pipeline/hollow cylindrical delivery device while still retrieving the line carrier and successfully completing the circuit.

23. The method of installing pull line through an open-ended conduit/pipeline/hollow cylindrical delivery device as indicated in claim 17., wherein:
the method of connection as illustrated and claimed therein is not construed to restrict the claim so as not to allow any other developed method of connection thereto to be added or claimed by the inventor at such future as time may warrant.

24. The apparatus according to claim 1., wherein;
it is understood that the omission of any delivery device through which the apparatus can be adapted is not to limit the possibility of same being used and claimed to work in any such omitted device at some future point by inventor as time may warrant.
